(19) United States
(12) Patent Application Publication
(10) Pub. No.: US 2014/0164076 A1
(43) Pub. Date: Jun. 12, 2014

(54) Systems, Methods, and Interfaces for Generating and Sampling a Mailing Service Campaign

(71) Applicant: VISTAPRINT TECHNOLOGIES LIMITED, Hamilton (BM)

(72) Inventors: John C. Marcos, Belmont, MA (US); William K. Doggett, III, Acton, MA (US); Elona Prilutsky Jaquez, Burlington, MA (US); Dana Ward, Belmont, MA (US); Mansi Mohnani, Cambridge, MA (US)

(73) Assignee: VISTAPRINT TECHNOLOGIES LIMITED, Hamilton (BM)

(21) Appl. No.: 13/710,453

(22) Filed: Dec. 10, 2012

(51) Int. Cl. G06Q 30/06

(52) U.S. Cl. CPC G06Q 30/0641
USPC 705/14.4; 705/26.8

(57) ABSTRACT

Integrated printed product design, production, and mailing services systems, methods and user interfaces which allow businesses and consumers to quickly design a product for a mailing campaign, provide/select/purchase a mailing list, and simply order an integrated mailing services product which includes the production, addressing, application of postage, and mailing of the printed advertisement product to the set of desired recipients.

### INCORPORATION BY REFERENCE

The following patents and patent publications are hereby incorporated by reference for all that they teach: U.S. Pat. No. 6,650,433, entitled “Managing Print Jobs”, issued Nov. 18, 2003.

### BACKGROUND OF THE INVENTION

The present invention relates general to services which address and mail out documents for third parties, and more particularly to systems, methods and interfaces for generating and sampling a mailing services campaign.

Small and large businesses often advertise their business by mailing postcards, brochures, and other advertisements to potential customers. FIG. 1 shows a schematic diagram illustrating the typical process for generating a mailing campaign. As illustrated, a customer 1 (such as a business or agent of the business) typically works with a designer service 2 to develop an advertisement design for a printed document (such as a postcard, a fold-over, a brochure, or other document to which a mailing address can be applied and mailed. The document design generally includes customer content and a space for printing or otherwise adhering a recipient address. The document design does not include the recipient address, and is referred to herein as an “address-free” document. The designer service 2 may supply the customer with the address-free document 3 in an electronic format (for example, a print-ready file such as in .pdf or other Postscript format). Alternatively, or in addition, the designer service 2 may work with a print service 4 to produce physical prints of the address-free document 3 and supply the prints to the customer 1.

Once an address-free document 3 is generated, if the customer 1 received the address-free document 3 only in an electronic format, the customer 1 may then work with a print service 4 to order the physical prints of the address-free document 3. Alternatively, the physical prints may be produced or ordered by a mailing service 6.

The customer may then work with a mailing service 6 to outsource the addressing and mailing of the address-free document to a number of recipients. The customer 1 provides a mailing list to the mailing service 6. The mailing list contains names and associated addresses of intended recipients 9a, 9b, . . . , 9n of the mailed document. The mailing service 8 receives the address-free document 3 (in either electronic or printed form), prints the address-free document 3 to generate prints (if the received address-free document 3 was received in electronic form), applies a different address from the received mailing list to each print, applies postage, and delivers the postage-applied prints to a postal service 8 (e.g., a government-sponsored or private postal delivery service) for delivery to the addressed recipients 9a, 9b, . . . , 9n.

As can be appreciated from the above description, executing a mailing campaign often involves the coordination of multiple different parties (customer 1, designer service 2, print service 4, mailing service 6, postal service 8), which often leads to substantial costs and time delay. Many businesses, especially those without the dedicated resources needed to manage such mass-mail marketing campaigns, are faced with the dilemma of having to decide between taking the time away from revenue-generating work (i.e., performing the substantive services or producing the products of the business) and missing out on marketing opportunities which may drive customers to the business through a mass-mail marketing campaign. Accordingly, it would be desirable to have an integrated printed product design, production, and mailing services system which would allow businesses to quickly design a product for a mailing campaign, provide/select/purchase a mailing list, and simply order an integrated mailing services product which includes the production, addressing, application of postage, and mailing of the printed advertisement product to the set of desired recipients. It would further be desirable to design and order the integrated mailing services product over the Internet via any Internet-enabled computing or mobile device. It would still further be desirable to be able to order a sample product to be able to examine the physical product to be produced, and to test out the time of delivery. Systems, methods and user interfaces described hereinafter address these needs.

### SUMMARY OF THE INVENTION

Embodiments of the invention include integrated printed product design, production, and mailing services systems, methods and user interfaces which allow businesses and consumers to quickly design a product for a mailing campaign, provide/select/purchase a mailing list, and simply order an integrated mailing services product which includes the production, addressing, application of postage, and mailing of the printed advertisement product to the set of desired recipients. Further embodiments allow the design and ordering of the integrated mailing services product to be conducted over the Internet via any Internet-enabled computing or mobile device. Still further embodiments allow the ordering of a sample product to allow the customer to be able to examine the physical product to be produced, and to test out the time of delivery.

In an embodiment, an integrated document creation and mailing service user interface includes a document creation interface configured to allow a user to create a document to be mailed by a mailing service, a mailing list interface configured to allow the user to specify a mailing list of addresses to which the created document is to be mailed, and a mailing services order interface configured to allow the user to specify a mailing services level, to place an order with a mailing services provider to produce and mail the created document to recipients having addresses in the mailing list, the mailing services order interface configured to link the created document and specified mailing list into an integrated mailing services product and to associate the integrated mailing services product with an account associated with the user.

In another embodiment, a method and apparatus allow a customer of a mailing services provider to order a sample and test a delivery service of the mailing services provider by providing a graphical user interface configured to allow the user to create or provide an electronic document from which a mailpiece can be produced and mailed by the mailing services provider, the electronic document comprising at least one content area comprising user content and including at least one area reserved for a recipient address, and further by providing a graphical user interface configured to allow the user to order a physical sample of the mailpiece and to specify a delivery service level.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic block diagram illustrating the environment in which a typical prior art mailing campaign is executed.

FIGS. 2A and 2B are schematic diagrams of the front side and back side, respectively, of a postcard product typically generated in a mailing campaign;

FIG. 3 is a schematic block diagram of an exemplary system in which embodiments of the invention may operate;

FIGS. 4A-4T are screenshots of an exemplary embodiment of a user interface illustrating a guided flow for designing a mailpiece, selecting a mailing list, and ordering an integrated mailing services product;

FIGS. 5A-5G are screenshots of an exemplary embodiment of a user interface illustrating a guided flow when the user chooses to order a mailing services sample;

FIG. 6 is a flowchart illustrating an exemplary embodiment of a method for creating and ordering an integrated mailing services product; and

FIG. 7 is a flowchart illustrating an exemplary embodiment of a method for ordering a sample of the product for allowing a user to examine the quality of the product and test the delivery service of the integrated mailing services product.

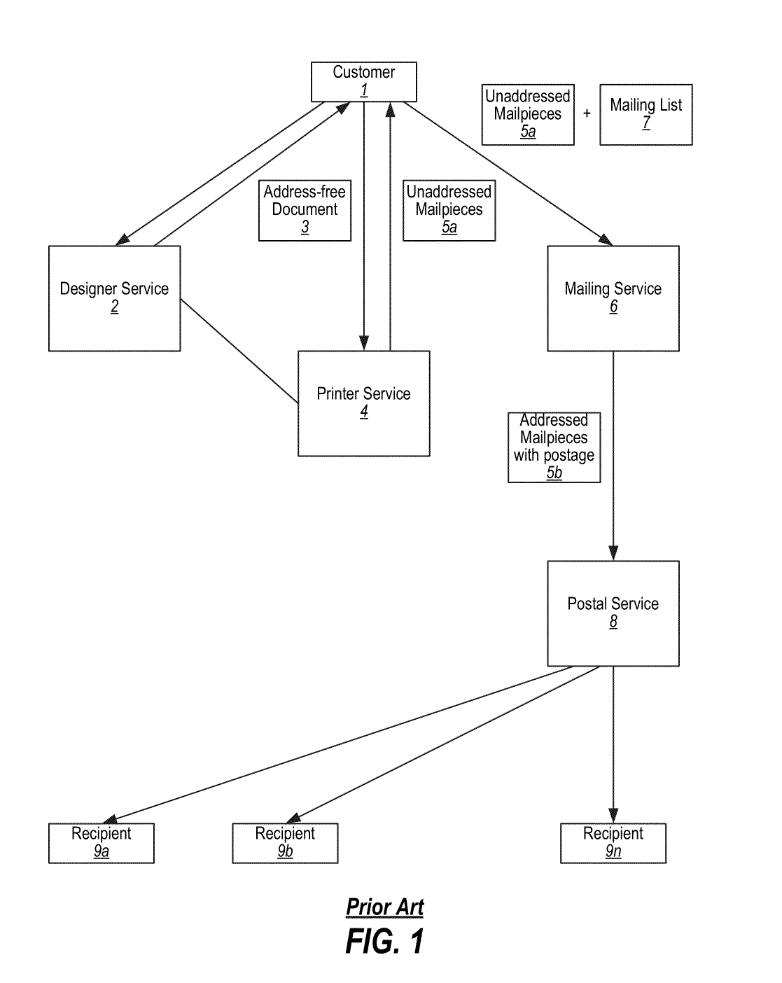

### DETAILED DESCRIPTION

As noted in the background section, previous techniques for generating a mailing campaign involved the coordination of multiple parties for designing, printing, selecting/producing a mailing list, addressing and applying postage, and delivering a mail product to a number of intended recipients. Described in detail herein are integrated printed product design, production, and mailing services systems, methods and user interfaces which allow businesses and consumers to quickly design a product for a mailing campaign, provide/select/purchase a mailing list, and simply order an integrated mailing services product which includes the production, addressing, application of postage, and mailing of the printed advertisement product to the set of desired recipients.

A mailing services provider operates to apply addresses and postage to, and mail, mailpieces to address recipients specified in a mailing list. The mailing services provider typically receives a stack of mailpieces, which are typically identical in content with a blank reserved area where individual addresses from a mailing list are printed or otherwise affixed. The mailing services provider may also receive a mailing list from a customer. Alternatively, the mailing services provider may allow the customer to purchase a mailing list from the mailing services provider.

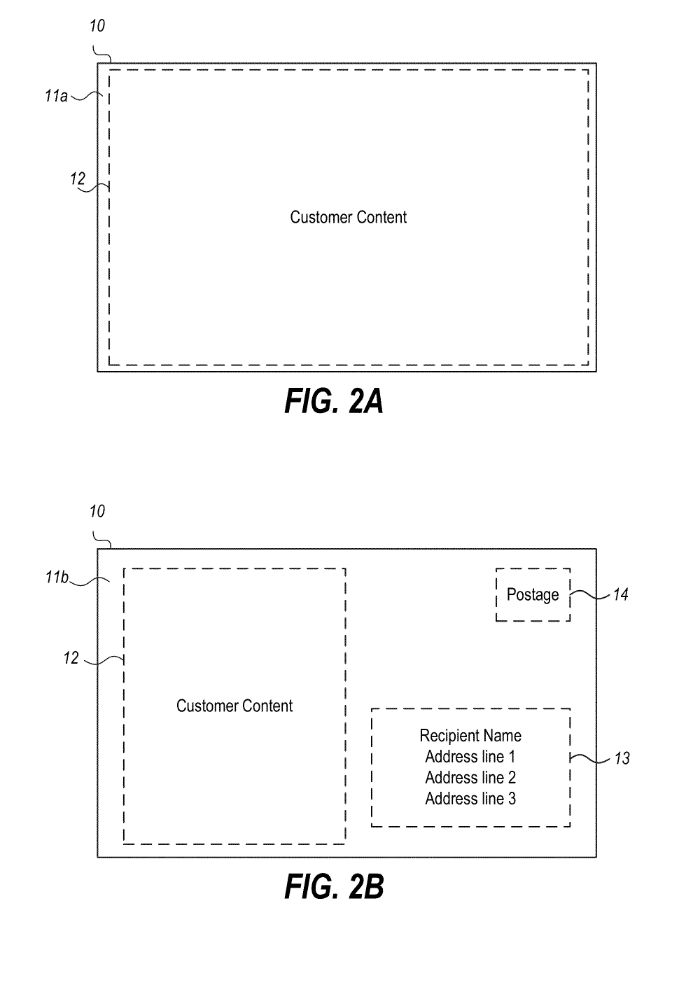

Common types of mailpieces processed by a mailing services provider include postcards, brochures, fold-overs, filled envelopes, etc. To provide context for ensuing discussion, FIGS. 2A and 2B are schematic diagrams of the front side and back side, respectively, of a postcard product 10 that is often mailed out as part of an advertising campaign. As shown, the front side 11a of the postcard 10 contains content provided by the mailing services provider customer (i.e., “customer content” 12). The customer content 12 may include one or more, or any combination of, text, images, graphics, and even different areas of texture. As further shown, the back side 11b of the postcard contains at a minimum an address area 13 and a postage area 14. The back side 11b of the postcard 10 may also include further customer content 12 in areas not reserved for recipient address and postage and other mail processing.

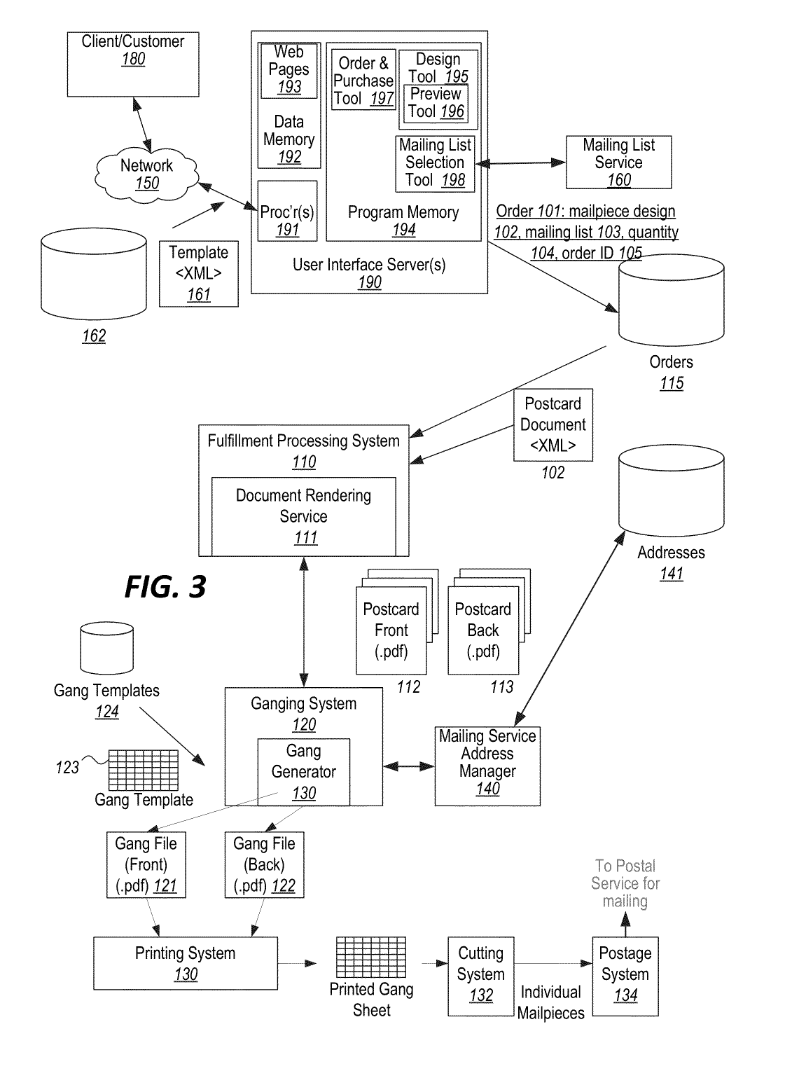

In accordance with some aspects of the invention, a system for designing and ordering an integrated mailing services product, including a mailpiece design and associated mailing list, provides a simple guided user interface that guides a user through the design of a mailpiece, providing creative editing tools, and further guides the user through creation, selection, or purchase of a mailing list, and through delivery and service level selections of the mailing service. FIG. 3 is a schematic block diagram of an exemplary system 100 in which embodiments of the invention may operate. As indicated, the system may include individual components, including User Interface Server(s) 190, a Mailing List service 160, a Fulfillment Processing System 110, a Ganging System 120 including a Gang Generator 130, a mailing services Address Manager 140, and a Printing system 130.

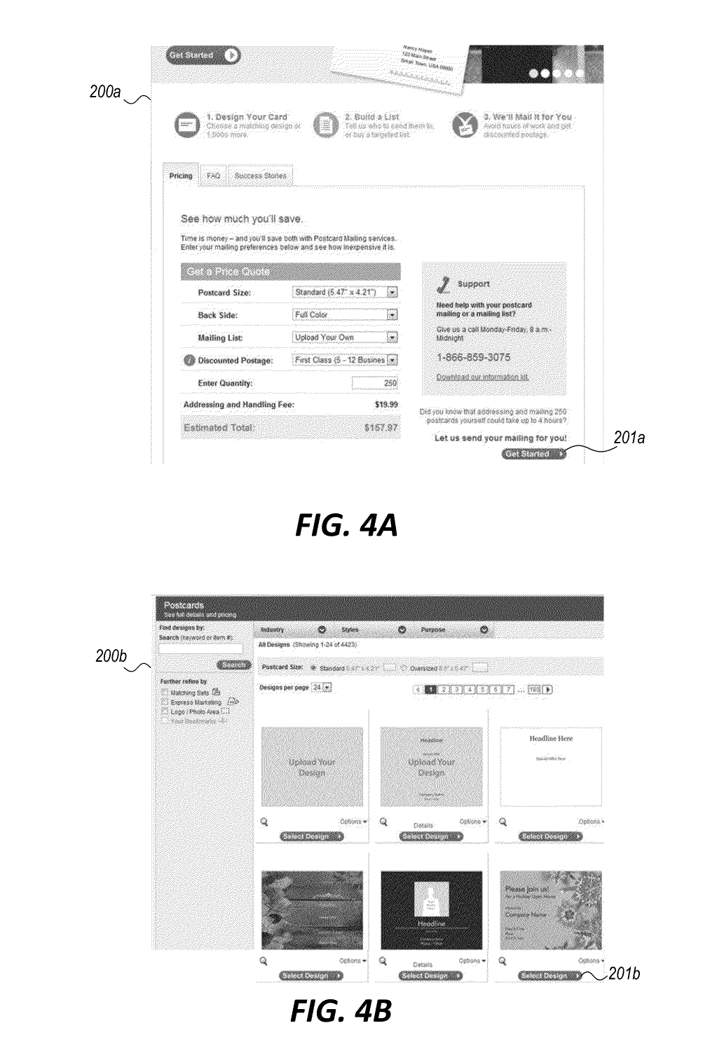

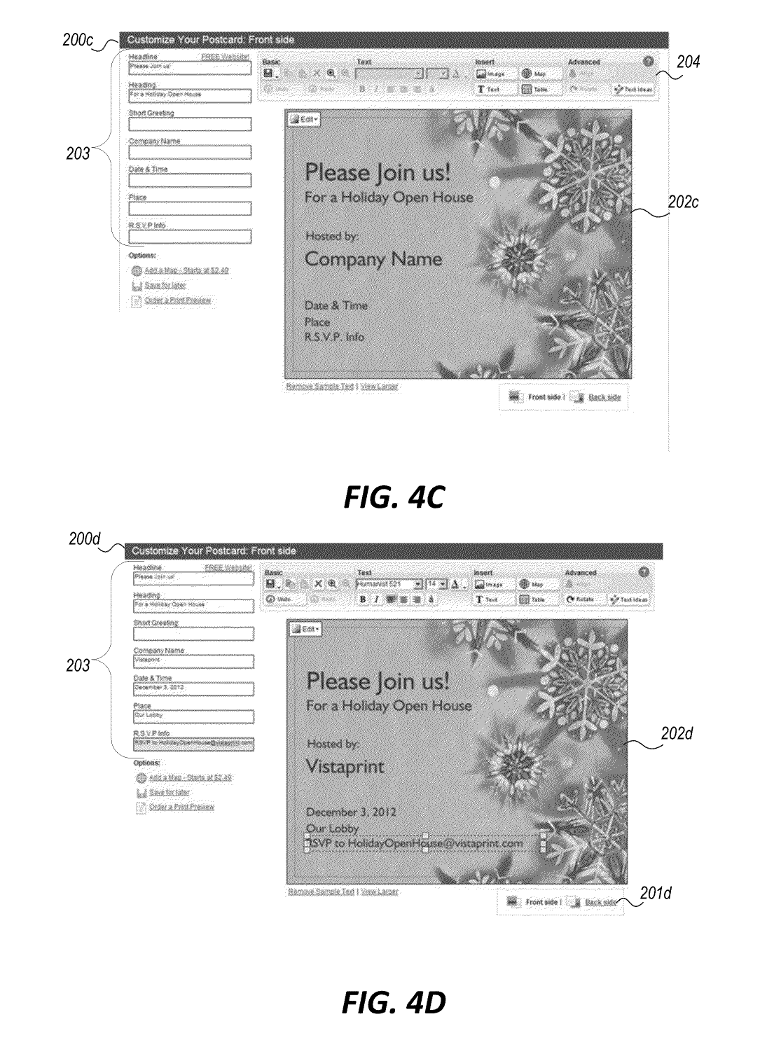

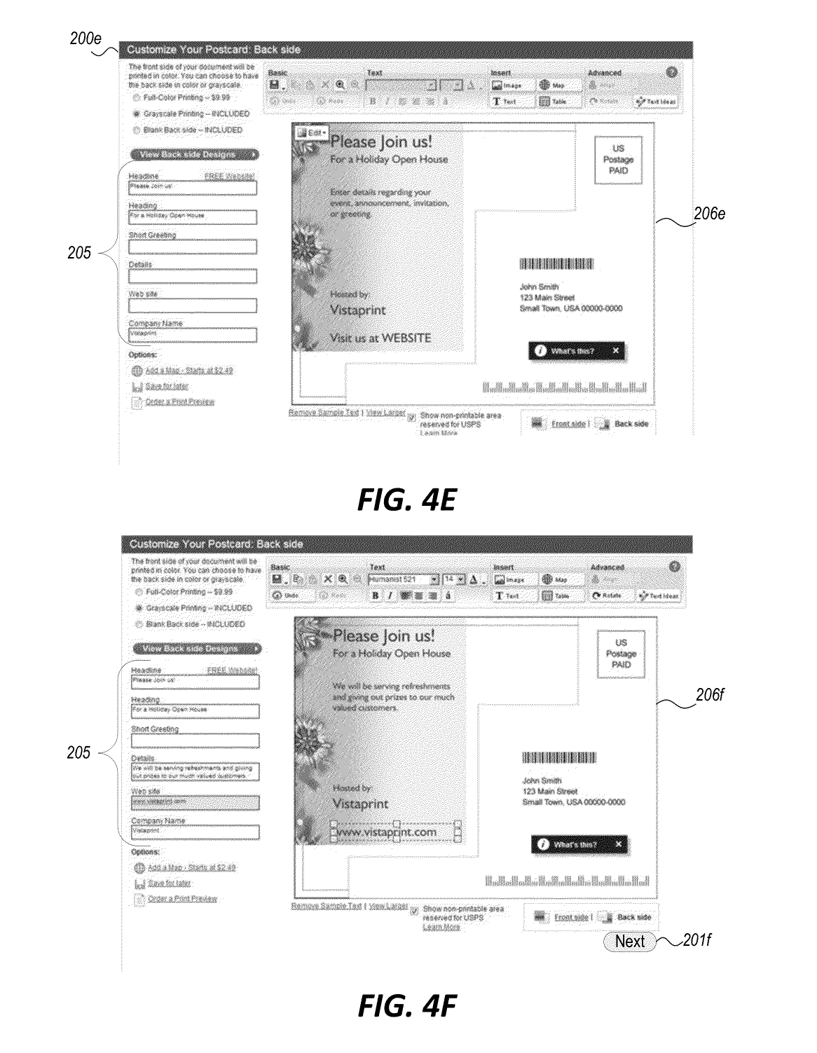

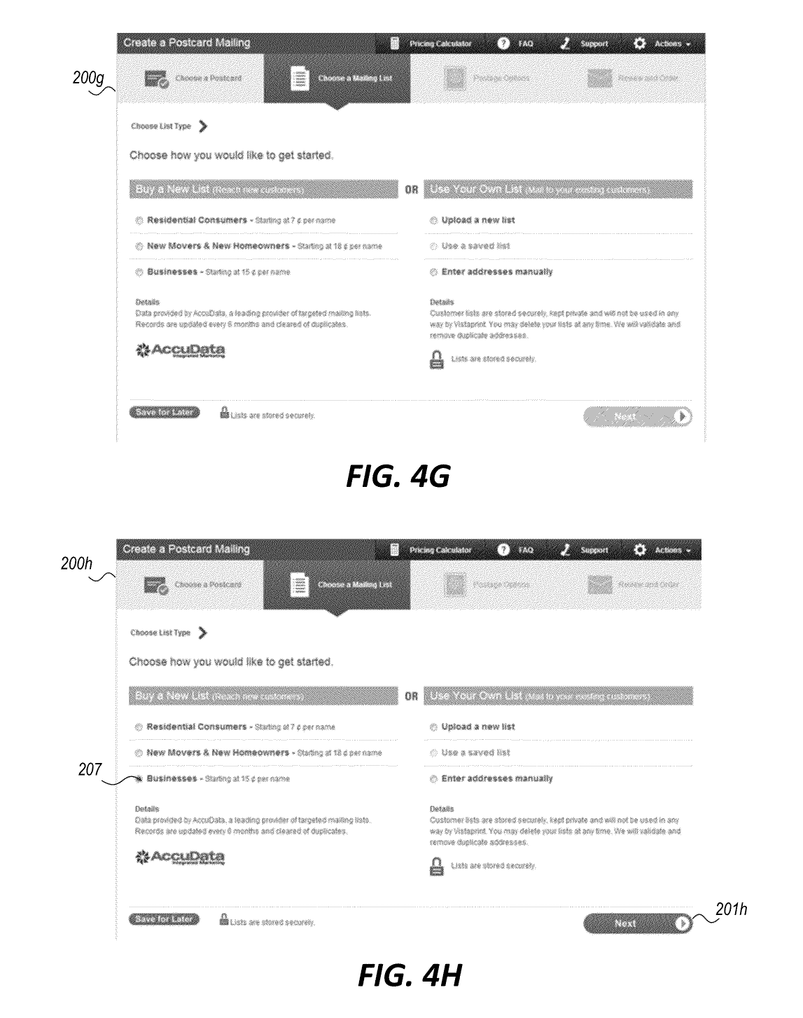

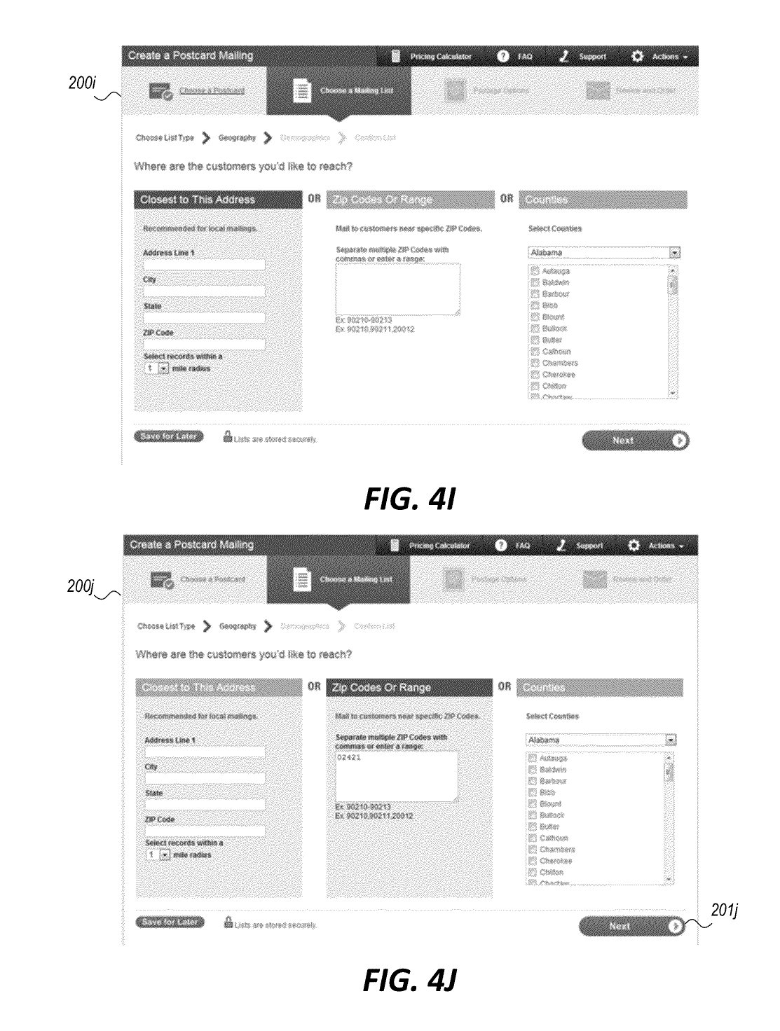

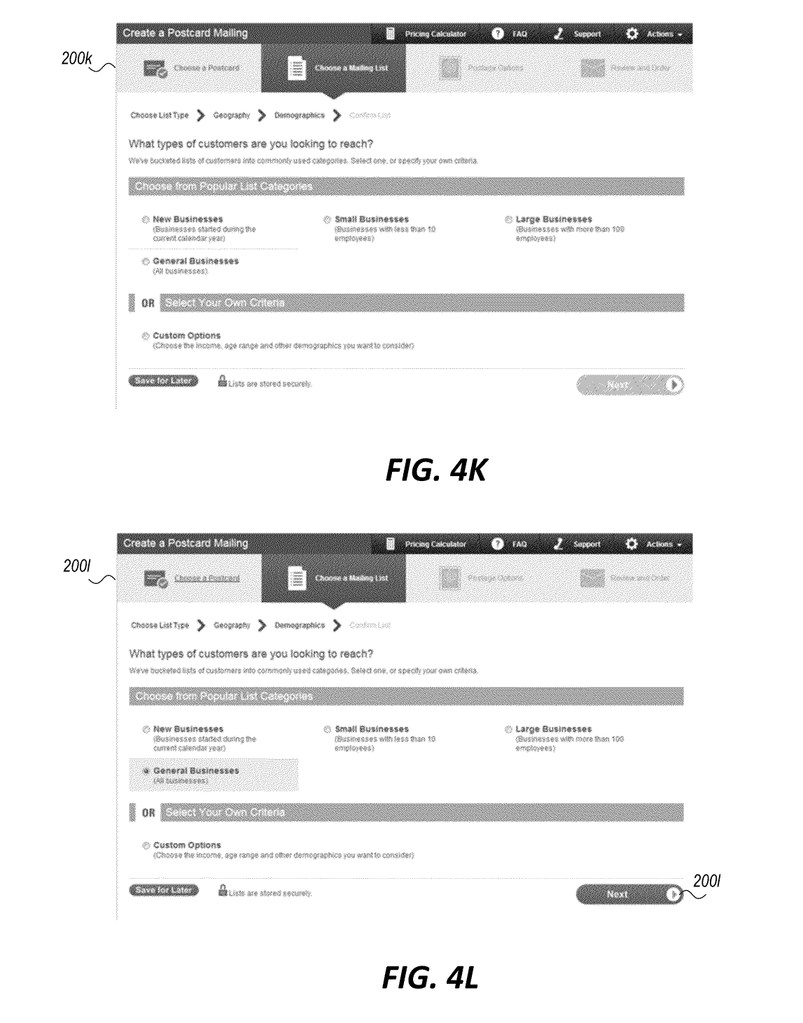

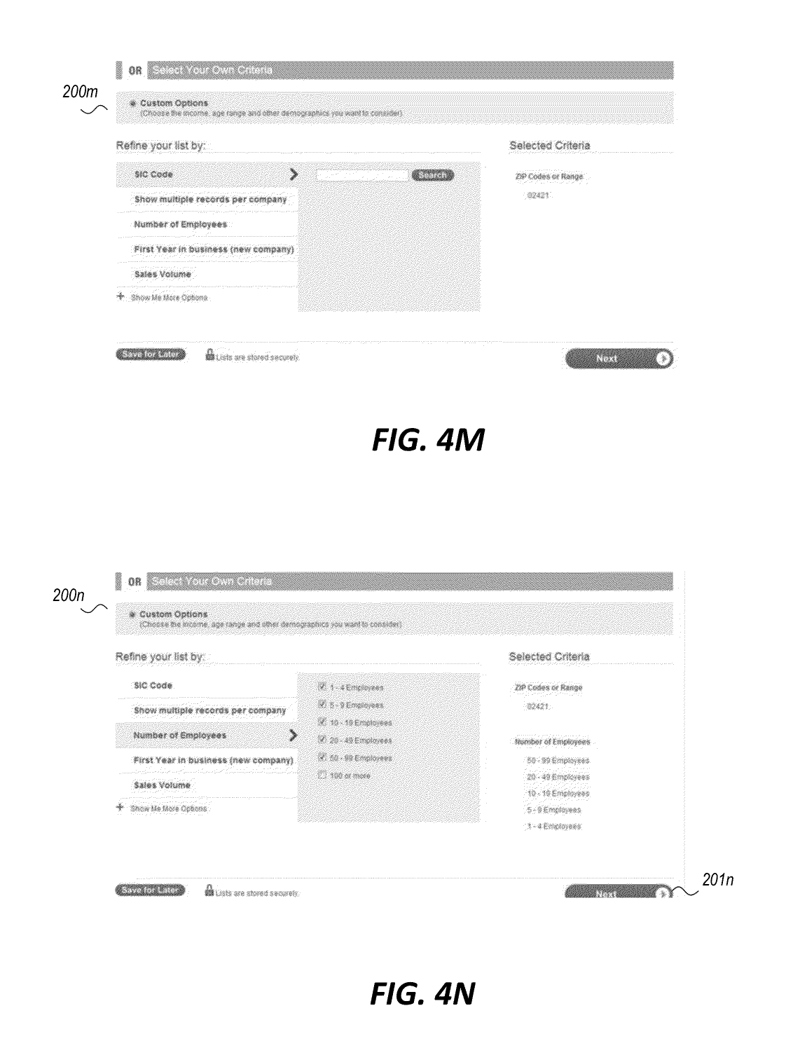

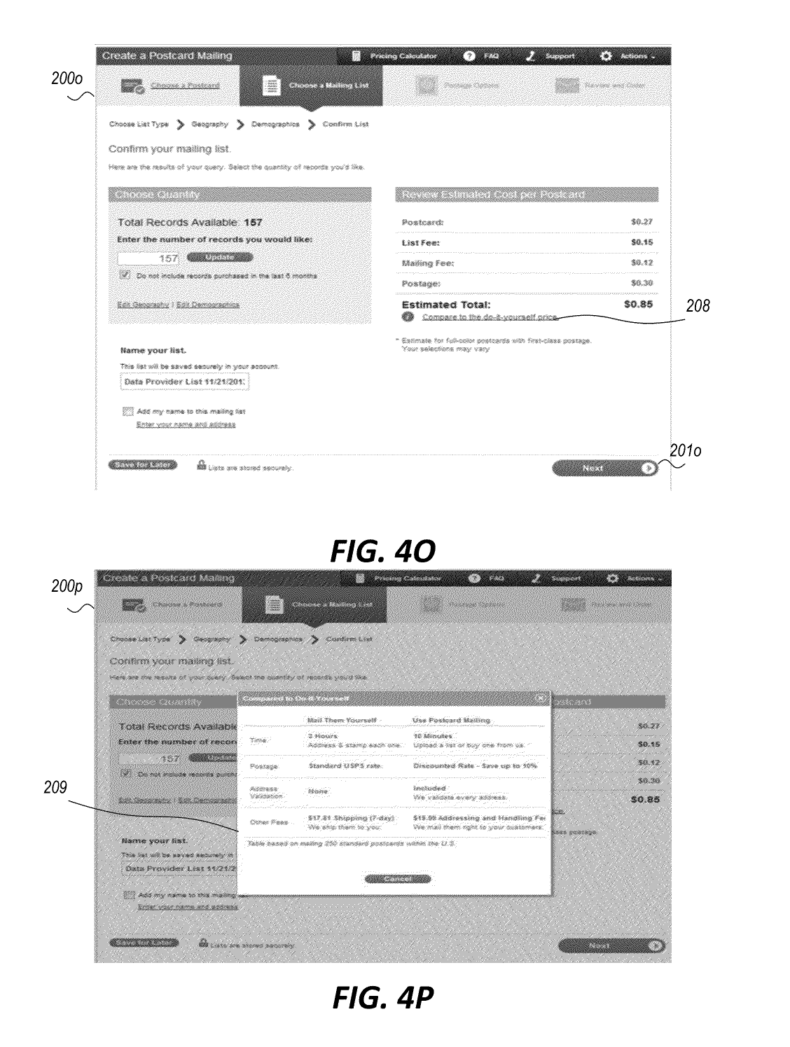

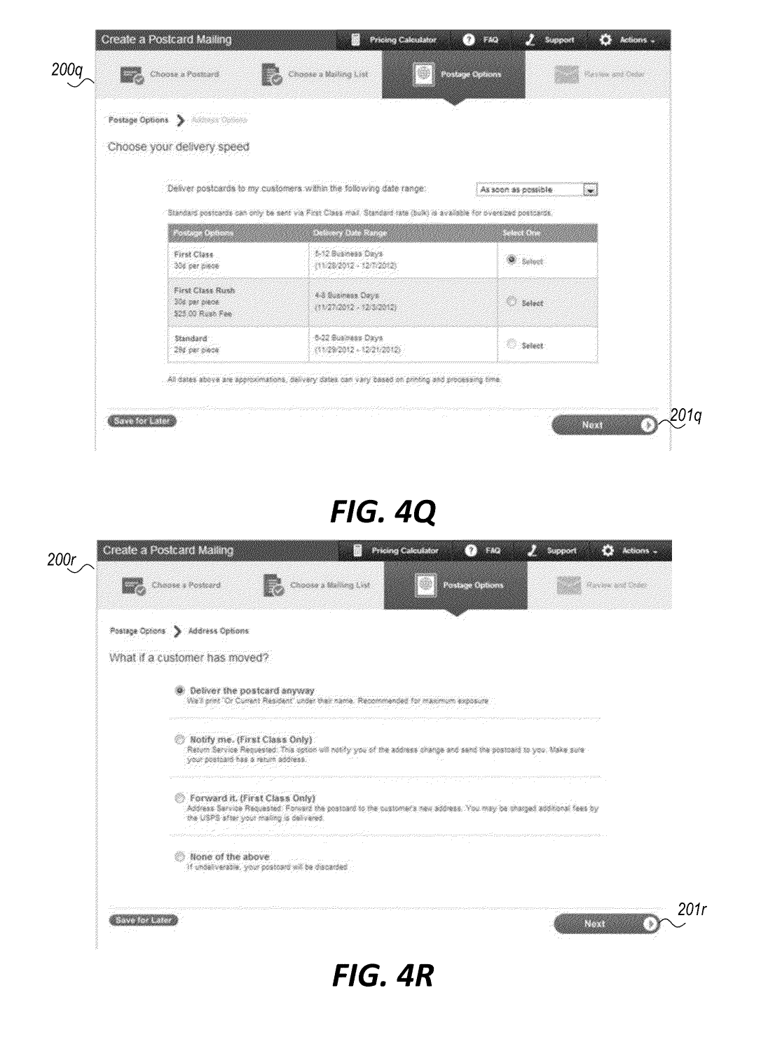

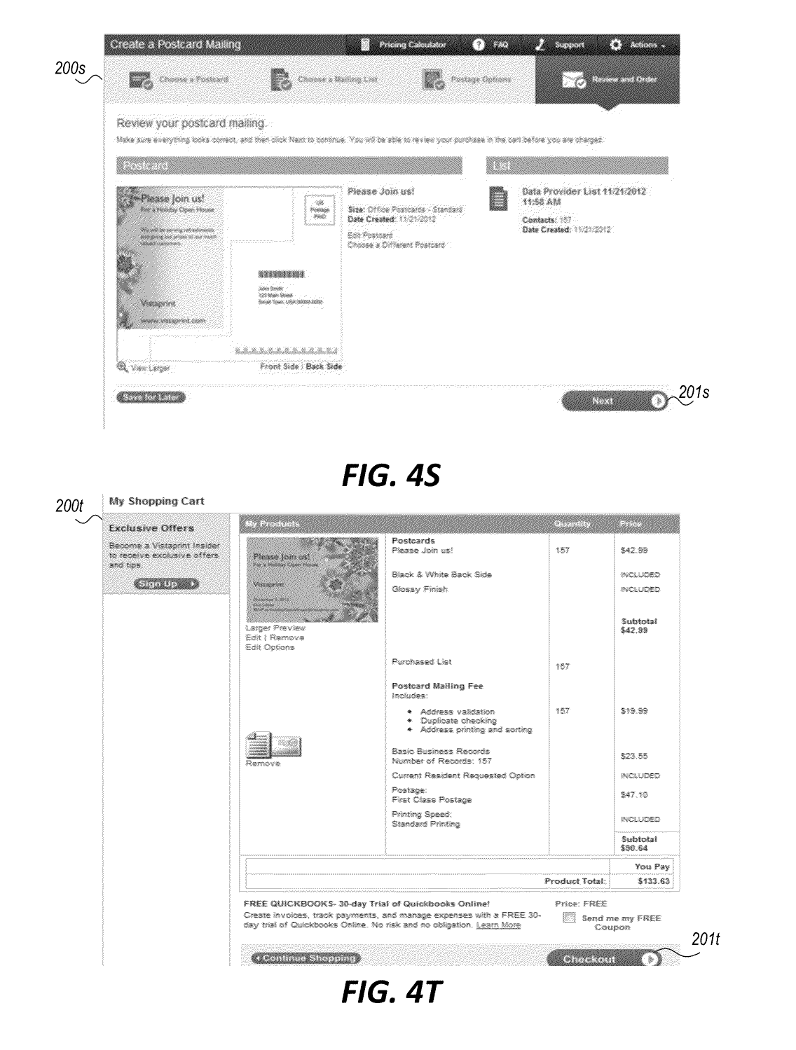

Any number of customers operating client computers 180 may access, via a network 150 such as the Internet, a mailing services provider's website hosted by the User Interface server(s) 190 to create and order mailing services products and to order samples prior to ordering an integrated mailing services product. Multiple templates for a mailing services product mailpiece such as a postcard are stored in a server-accessible database 162. The templates are typically stored as in a markup language format such as eXtensible Markup Language (XML) which specifies in XML format a set of components such as a layout, one or more images, one or more text containers, a font scheme, a color scheme, etc. Templates 161 may be selectable by the customer (see FIG. 4B) for further customization such as adding customer-personalized information such as name, business name, address, phone number, website URL, taglines, etc. (see FIGS. 4C-4F) A template may include image containers allowing the user to upload images into the design of the postcard.

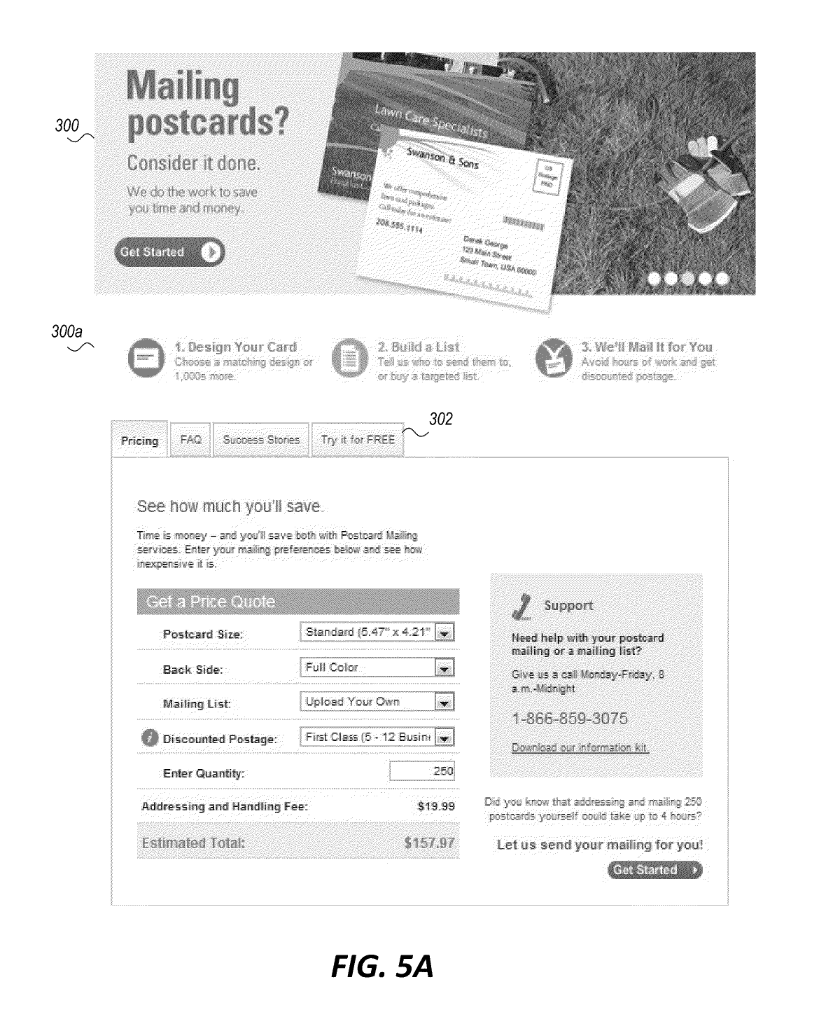

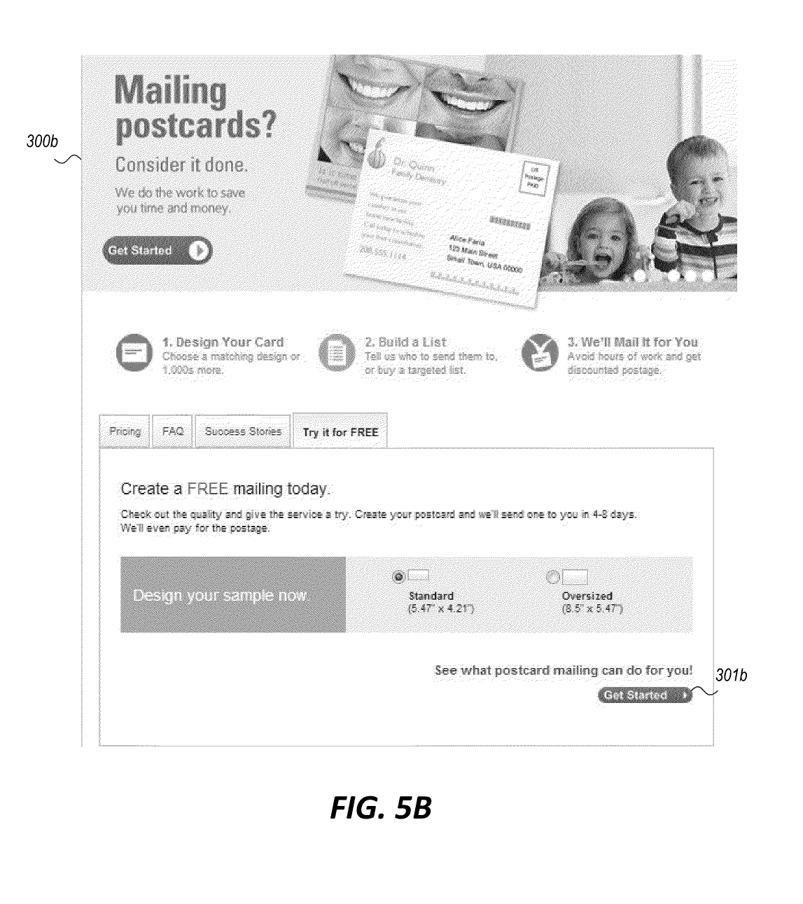

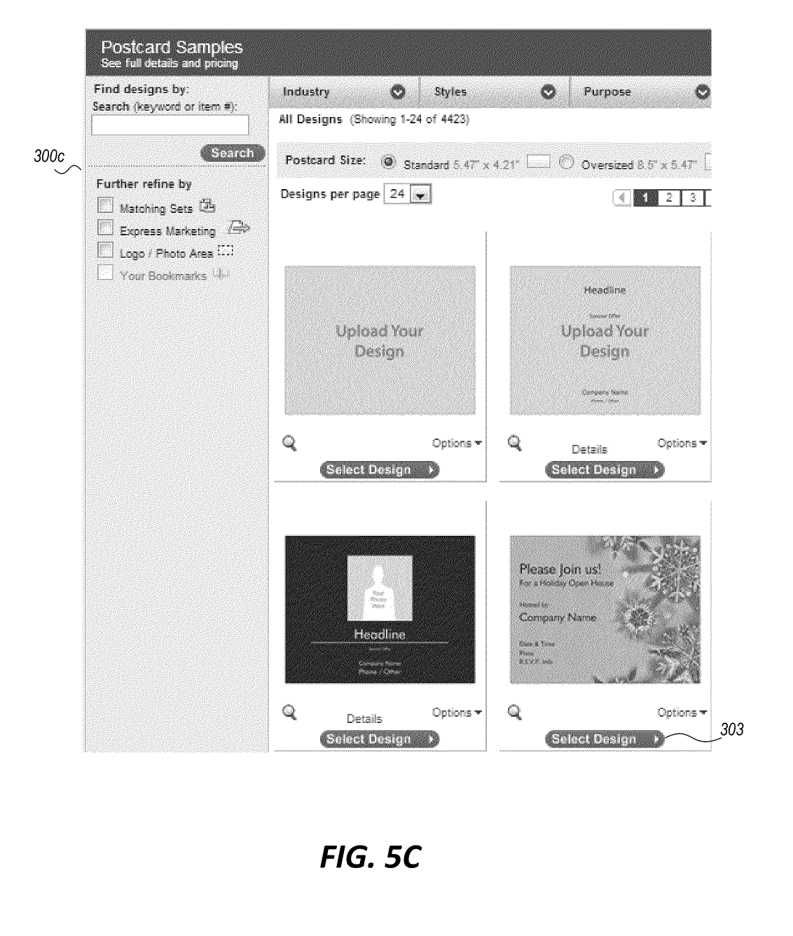

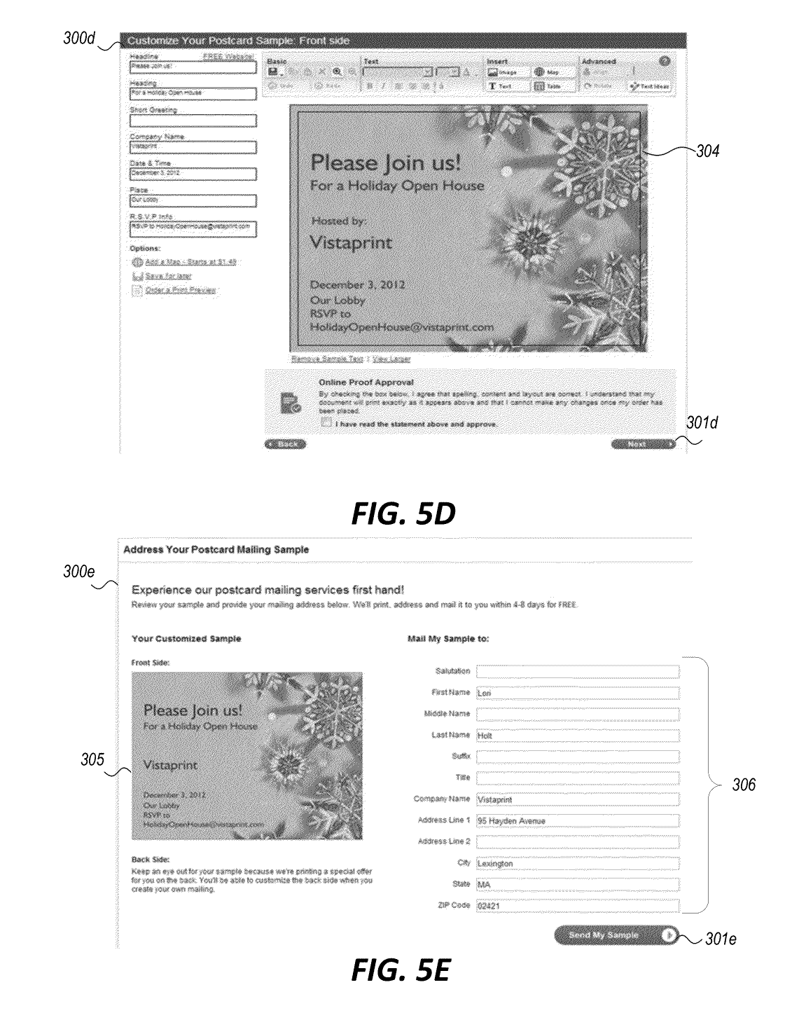

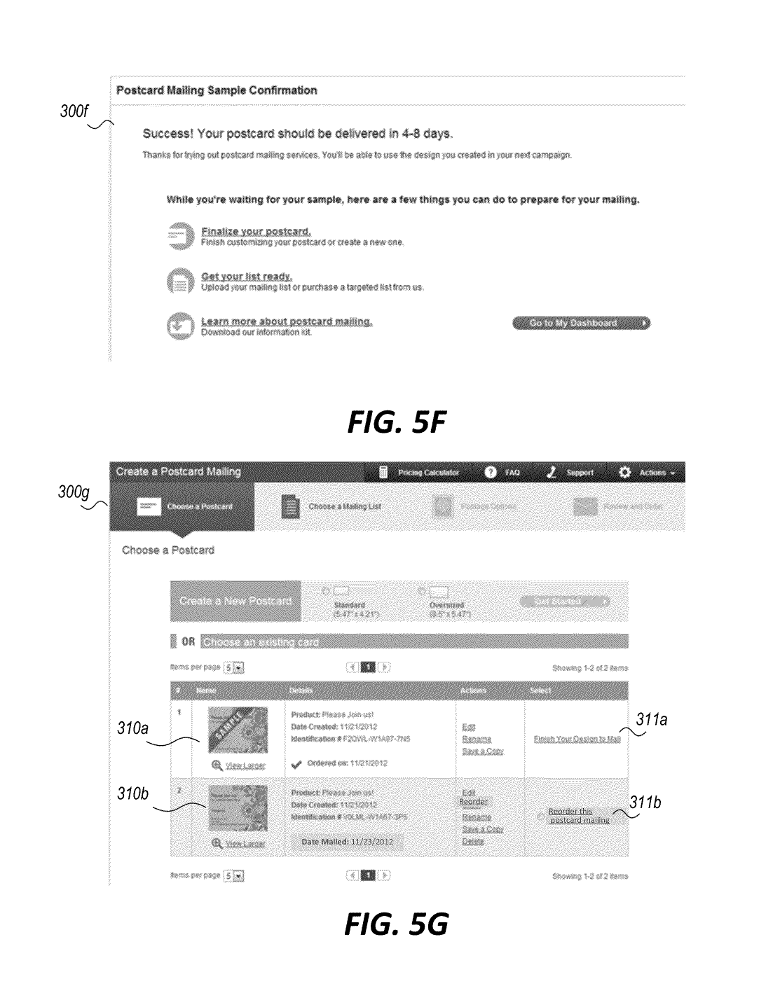

The user interface server(s) 190 include one or more processor(s) 191, data memory 192 storing a set of web pages (see FIGS. 4A-4T and 5A-5L) which together provide a guided journey from selecting a mailpiece template and editing it to generate a customized mailpiece design, selection of a mailing list and postage/delivery options, and ordering an integrated mailing services product. One or more interfaces are provided by user interface server(s) 190. In an embodiment, the interfaces include a designer interface which is provided by a design tool 195, a mailing list selection interface which is provided by a mailing list selection tool 198, and an order and purchase interface which is provided by an order and purchase tool 197. In an embodiment, each of the tools 195-197 are implemented as computer readable program instructions tangibly embodied in program memory of a computer readable storage medium. The design tool 195 may include a preview generator tool 196. The design tool guides the user through the selection and design of a mailpiece design, for example as illustrated in FIGS. 4A-4F. Once a customer is satisfied with the mailpiece design, the web pages 193 guide the user to the mailing list selection interface, which guides the user through mailing list selection and filtering. The ordering interface guides the user through postage and delivery selection, number of mailpieces in the order, etc. An order 101 for the integrated mailing services product can be placed through the server 190.

Integrated mailing service product orders 101 are either sent directly to the fulfillment processing system 110 or are placed in an order database 115 and accessed (i.e., pulled from the database 115) by fulfillment processing system 110. Each order 101 includes, either directly (i.e., the actual item itself) or indirectly (i.e., by reference using an identifier from which the actual item can be obtained), at least the following items: the mailpiece design 102 (i.e., the print information to be printed on every mail item), the mailing list 103 (which can be an identifier), a specified quantity 103 of mail items to be printed, and an order identifier 104. Additional items may be included in the order, such as a desired mailing or deliver-by date, a delivery service level (e.g., 1^{st} class mail, 2^{nd} day, standard, etc.), other parameters such as Oversize status, card stock, etc. and other typical print order details such as customer identifier, customer contact and billing address, billing information, etc.

Each mailing services product order 101 has an associated address list (see 200 in FIG. 2) containing a plurality of unique mailing addresses to be used in printing the mailing services product.

In production, the fulfillment processing system server 110 may retrieve orders 101 from the order database 115, extract individual item documents 102 from the retrieved orders 101, and using a document rendering service 111, convert the individual item documents 102 into a set of related individual postscript files 112, 113. A ganging system 120 aggregates individual ordered items 102 into a set of related gangs 121, 122 of individual items to be manufactured, and prints the items a “gang” at a time. For postcard mailpieces, the post back 113 item of a particular ordered item 102 must be organized into the gang such that it will be printed on the back side of the related front side 112 when the gangs 121, 122 are printed front and back. In other words, the front and back content of each ordered item 102 must align in the same footprint so as to produce the front and back content of the postcard when the gangs are cut into individual printed items.

Postage can be printed at the same time as the back side content (along with the individual recipient mailing addresses). Alternatively, a separate postage applicator system 134 may apply postage to each mailpiece at the end of the process but prior to depositing the mailpieces into the hands of a postal delivery service.

An exemplary set of screenshots illustrating an embodiment of the user interface which provides a guided flow through the designing and ordering of an integrated mailing services product and service is shown in FIGS. 4A-4T. As illustrated in FIG. 4A, a web page 200a of a mailing services provider displays a process flow (e.g., “1. Design Your Card. 2. Build a List. 3. We'll Mail it for You”), along with pricing information and other information. The page 200a can be shown before or after a user selects a mailing services product type (e.g., a postcard, a brochure, etc.) In the illustrated embodiment, page 200a is shown after the user has navigated to the postcard product type. The page 200a includes a control 201a, e.g., a “Get Started” link, which if clicked on by the user, results in the display of web page 200b, shown in FIG. 4B.

Page 200b displays a gallery of different templates which the user can select as a starting point for customizing the postcard design. Different templates may be in various stages of completion. For example, some templates may be used to allow the user to upload an image to be used as the entire design. Other templates may include pre-selected images, text, layouts, backgrounds, styles, and color schemes, which include some user-editable components. Within the gallery, each template is displayed as a thumbnail image and has associated therewith a control (e.g., hyperlink “Select Design”) for selecting the associated template.

FIG. 4C is a web page 200c displayed after a user selects the control 201b in page 200b. In this embodiment, a design studio is downloaded from the server to the client to execute in the user's browser. The design studio includes a preview area 202c in which a preview image of the front side of the postcard design is displayed. Upon selection in the gallery (FIG. 4B) of a particular template, a preview image of the template is loaded into the preview area 202c. The design studio also includes a set of form fields 203 which map to user-editable text boxes in the design template. The design studio also includes a set of editing tools, shown in toolbar 204, which provide capability for editing the font, size and style of text, inserting additional text or image containers and filling them with selected images or text, etc.

The user can edit the text of the template to create a customized design for the front page of the postcard mailpiece. FIG. 4D shows a web page 200d with the preview image 202d after the user has filled in the Company Name field, the Date & Time field, the Place field, and RSVP information field in the corresponding form fields 203 of the design studio. When the user is satisfied with the design of the front side design of the postcard mailpiece, the user is then directed to designing the back side of the postcard mailpiece. The user can edit the back side by clicking on the control “Back side” 201d.

FIG. 4E is a web page 200e displayed after a user selects the “Back side” control 201d in page 200d. In the illustrated embodiment, the design studio displays a preview image 206e of the back side of the postcard design. The design studio displays a set of form fields 205 which map to user-editable text boxes in the back side design template. FIG. 4F shows the preview image 206f after the user has filled in the Details field and Web site field in the corresponding form fields 205 of the design studio. When the user is satisfied with the design of the back side design of the postcard mailpiece, the user can click on the “Next” hyperlink 201f, which directs the user to the next phase of the integrated mailing services product—namely, the selection of a mailing list.

Page 200g in FIG. 4G is an exemplary embodiment of the mailing list interface in which the user is assisted in selecting a mailing list for the integrated mailing services product. In the illustrated embodiment, the user can optimal to upload a new list (the user provides the mailing list), use a saved list (i.e., one that was previously uploaded or created or purchased), create a new list by entering addresses manually, or purchase a list. FIG. 4H shows the web page 200h after the user has selected to purchase a list of business addresses (by clicking on the radio button 207 under the “Buy a New List” heading. The user can then click on the “Next” control 201h, which results in the display of web page 200i shown in FIG. 4I. Web page 200i presents filter fields such as “Closest to This Address” fields, “Zip Codes or Range” fields, or “Counties” fields. In FIG. 4J, web page 200j shows a user has selected the Zip Codes field, and entered a zip code in which the business addresses should be located. After clicking the “Next” link 201j in web page 200j, the user is presented with the web page 200k shown in FIG. 4K. On this page, the user can further filter the mailing list by choosing from a popular list of categories of selection criteria or entering custom criteria. In FIG. 4L, the web page 200l shows that the user has selected the General Businesses selection criteria from the Popular List of Categories. Upon selecting the “Next” linke 201I in web page 200I, the user is presented with the web page 200m shown in FIG. 4M.

In FIG. 4M, the user may further refine the mailing list using additional filters: SIC Code, Multiple Records per Company, Number of Employees, First Year in Business (New Company), Sales Volume, etc. FIG. 4N shows the web page 200n after the user has selected to further refine the mailing list based on number of employees. Upon clicking on the “Next” link 201n, the user is presented with the web page 200o shown in FIG. 4O, where the user can enter the desired number of address records from the total available list of address records after the selected filters have been applied. The price of the selected number of records may also be displayed, along with a link 208 to allow the user to compare the quoted price to a do-it-yourself price. FIG. 4P shows a popup window 209 which may be displayed to the user after clicking on the “compare” link 208. The popup window displays a chart comparing the quoted price with the do-it-yourself price. The user can click on the “Next” link 201o to bring up the next web page 200q shown in FIG. 4Q, which display the list of postage and delivery date range options. The user can select a radio button associated with the desired postage/delivery option (e.g., First Class as shown in FIG. 4Q) and click the “Next” link 201q, which brings up the web page 200r shown in FIG. 4R. Web page 200r allows the user to choose delivery options when a mailing recipient has moved. In the illustrated example, the user has selected “Deliver the postcard anyway”. After clicking on the “Next” linke 201r, the user is presented with the web page 200s shown in FIG. 4S.

FIG. 4S is the integrated mailing services product review page 200s. As shown, the product (postcard mailing product) includes both the mailpiece design and the selected mailing list. The two are treated by the system as a single product. After reviewing the details of the postcard mailing product, the user clicks on the “Next” link 201s to land in the shopping cart, shown on web page 200t in FIG. 4T. After viewing the shopping cart with the pricing details, the user can then check out by clicking on the Checkout link 201t. The checkout process is similar to most online stores, where the user enters payment and other information and the order is processed after payment is made.

As will be appreciated from the above discussion and user interface flow, the present invention makes the creation of a mailpiece design and mailing list selection a simple integrated process. The user can quickly generate and order a mailing without having to call or interact with multiple service providers. The creation and generation is performed automatically by the mailing service provider server.

As mentioned above, often a purchaser of a product or service desires to touch and examine the product or try out the service prior to buying the product or service. FIGS. 5A-5G are screenshots of an exemplary embodiment of a user interface illustrating a guided flow when the user chooses to order a mailing services sample. FIG. 5A shows an introductory web page 300a which includes information such as pricing. It includes a control, such as tab 302 (“Try it for FREE”), which when clicked on, results in the display of web page 300b shown in FIG. 5B. Web page 300b displays an offer to the user to order a free mailing services postcard sample. The user can get started by clicking on the “Get Started” link 301b.

FIG. 5C shows the web page 300c which displays a gallery of postcard templates and associated selection controls. This page 300c is similar to web page 200b in FIG. 4B. Upon selection of a template selection control 303, the design studio is displayed, for example as shown in web page 300d in FIG. 5D, with the sample front side of the sample postcard displayed as a preview image. The studio operates the same as the design studio shown in FIGS. 4C and 4D, and the user can edit the content using the form fields and tools of the design studio as discussed previously.

In the illustrative embodiment, the mailing services provider has made the design choice to allow the user to only edit the front side of the sample card. The mailing services provider has reserved the back side content to place its own advertisement/offer. However, in other embodiments, the system can be configured to allow the user to edit both the front and back sides of the postcard (i.e., the mailing services provider can give the user full design capability). Upon clicking on the “Next” link 301d, a web page 300e is displayed, as shown in FIG. 5E. In web page 300e, the user is shown a preview image 305 of the front side of the postcard sample, and then the user is requested to enter the form fields 306 corresponding to the user's name and address where the sample is to be mailed. The user can then request the sample to mailed to him or her by clicking on the control 301e (“Send My Sample”), which instructs the server to generate an order to produce the sample mailpiece and mail it to the potential customer. A confirmation web page 300f is then displayed to the user, as shown in FIG. 5F. The confirmation page may include links to continue editing the postcard (for example, allowing the user to customize and edit the back side of the postcard), select a mailing list for later use, etc.

Although the delivery service time is defaulted to a fixed duration (4-8 days) in the flow of FIGS. 5A-5F, by design choice of the mailing services provider, in alternative embodiments the flow may include an option to allow the user to select the delivery service level (first class, second class, 2^{nd} day, etc.).

In an embodiment, ordered integrated mailing services products and ordered samples are associated with a user's account with the mailing services provider and saved for later editing, reorder, and/or copying and editing by the user when the user accesses their account. For example, FIG. 5G shows a web page 300g that is displayed to the user who created the postcard mailing product in FIGS. 4A-4T and who ordered the sample in FIGS. 5A-5F. As illustrated, the user is shown an image or other identification of previously ordered mailing services products and/or previously ordered mailing services product samples. In the illustrated embodiment, an image and description of each of the previously ordered products and samples is displayed. For example, an image of the sample postcard mailing product 310a is displayed, along with associated links to finish the design of the postcard mailing product. If the user clicks the Finish Your Design to Mail link 311a, the design studio is displayed and the design, mailing list selection, postage selection options, review and order flow is the same as shown at FIGS. 4C-4T.

For previously ordered mailing services products, such as the postcard mailing product identified at 310b, the mailing services provider provides links to reorder the integrated product 311b, edit the product, etc. If the user selects the Reorder link 311b, the same mailpiece is sent to the same mailing list with the same delivery options as the previous order. Upon clicking on the Reorder link, the integrated mailing services product is added to the user's cart and the user can check out. Thus, if the user does not desire to edit the mailpiece design, edit the mailing list or postage/delivery options, the user can potentially perform an entire reordered mailing campaign in two clicks (i.e., “reorder” link, checkout link) (without counting the payment process).

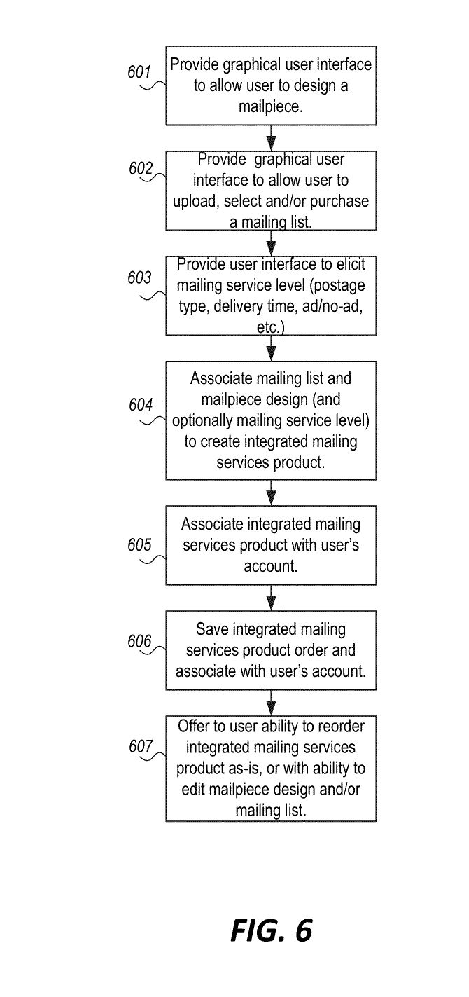

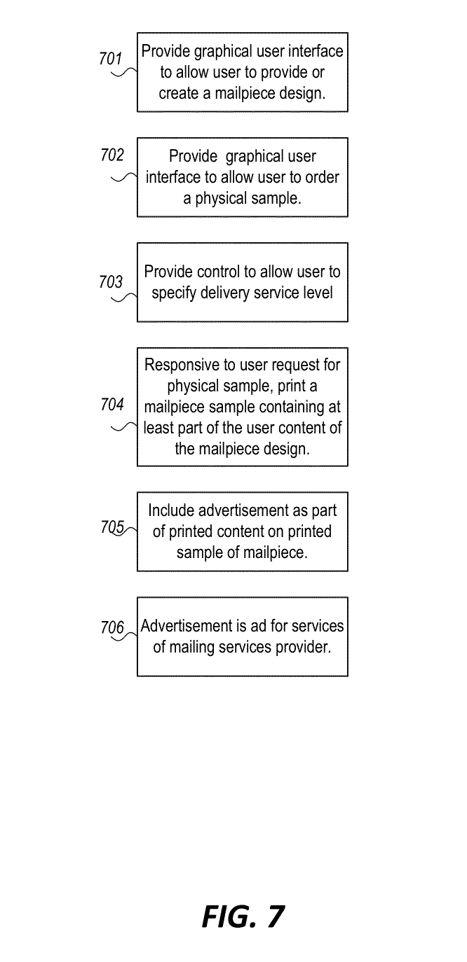

FIG. 6 is a flowchart illustrating an exemplary embodiment of a method for creating and ordering an integrated mailing services product. As illustrated, the mailing services provider provides a user interface, such as a WorldWide Web (.www) enabled website which provides a user interface to a user accessing the website over the Internet from a browser executing on a computing device (for example but without limitation: a desktop, laptop, tablet or pad, smartphone, or other mobile device). The user interface includes a graphical user interface such as a design studio configured to allow a user to design a mailpiece. The interface may enable the user to select from different mailpiece design templates, which typically include a mailpiece design layout, one or more images or graphics, text areas (which may include sample text). The templates are provided to operate as starting points for the user, to allow them to select a design with desired images and layout, and to then fill in personalized information to quickly complete a customized mailpiece design. The design studio generally includes editing tools configured to allow the user to input text into text areas of the template, and typically also provides controls to allow the user to change aspects of the design such as change the font selection, change the font size, change the color scheme of the design, insert additional text, insert or select and replace images, and move one or more design components (text, images) around.

Any give type of mailpiece may include one or more pages or areas to design. For example, a postcard (such as postcard 10 in FIGS. 2A and 2B) includes a front side 11a and a back side 11b. The front side 11a may be dedicated entirely to user content 12 and thus there may be no limitations on the content and location of the content on the front side 11a of the mailpiece design. In contrast, the back side 11b of a mailpiece needs to have both the the recipient address and the postage placed in respective particular areas 13 and 14 of the back side 11b of the design of the postcard 10. In this type of mailpiece product, the mailpiece templates may therefore lock out the user from editing these particular areas 13, 14.

By providing a graphical user interface to allow the user to design a mailpiece (step 501), the mailing services provider thus integrates the design step of the mailing campaign into the mailing service provided by the mailing services provider.

The mailing services provider also provides a graphical user interface configured to allow the user to configure a mailing list that includes recipient names and associated addresses of recipients who will receive the design mailpiece (step 502). In an embodiment, the graphical user interface provides options to the user to allow the user to choose whether to upload a mailing list provided by the user, or to select a subsection of recipients from an existing mailing list associated with the user, or to purchase a mailing list from the mailing services provider or a 3^{rd} party mailing list vendor. The graphical user interface may include a number of controls which allow the user to filter a mailing list to extract a targeted mailing list consisting of recipients who match the specified filter(s). For example, a user may wish to filter a list to target only a certain demographic. Such tools are offered in the user interface.

Upon selection of the mailing list to use for the mailing of the mailpiece, the mailing services provider provides a graphical user interface configured to allow the user to select a service level and finalize an order for an integrated mailing service product (step 503). The service level generally includes selections of desired delivery time, carrier service level (e.g., first class, second class, media, priority, etc.). Finalization of the order may include user input as to number of mailpieces to mail, date of mailing or desired delivery, and payment information.

The completed mailpiece and selected mailing list are associated with one another automatically at the mailing services provider server, and optionally associated with the selected mailing service level, to generate an integrated mailing services product (step 504). The integrated mailing services product is associated with the user's account (step 505) and saved by the server and associated with the user's account (step 506). The mailing services provider server allows the ability of the user to easily reorder the saved integrated mailing services product (step 507). The server can display an offer to the user to reorder the integrated mailing services product when the user accesses their account at a later date. In an embodiment, the user simply clicks on a control associated with the saved integrated mailing services product, and the user can then simply reorder the entire integrated mailing service product as is, including the same design, the same mailing list, and the same service level. A repeat mailing campaign can thus be generated in as little as two clicks of the mouse—one to click on the saved product, and one to click reorder with no changes.

In an alternative embodiment, the saved integrated mailing service product can be edited—the design can be edited, the mailing list can be edited, and/or the service level can be edited. Even with edits, by starting with a previously designed product, the user can quickly change up the content or targeted set of recipients and get the order processed within mere minutes.

Users are sometimes wary of placing an order for products and services without first touching and examining the product, or sampling the service. FIG. 6 is a flowchart illustrating an exemplary embodiment of a method for ordering a sample of the product for allowing a user to examine the quality of the product and test the delivery service of the integrated mailing services product. The method includes providing a graphical user interface configured to allow the user to create or provide an electronic document from which a mailpiece can be produced and mailed by the mailing services provider (step 601). The electronic document includes at least one content area comprising user content and includes at least one area reserved for a recipient address. The method further includes providing a graphical user interface configured to allow the user to order a physical sample of the mailpiece (step 602) and to specify a delivery service level (step 603). This feature allows a user to examine a physical product and to try out the desired delivery service before ordering an integrated mailing service product to perform a mailing campaign.

Upon receiving a request for a physical sample of the mailpiece, the mailing services provider produces a physical sample of the mailpiece associated with the request and mails it to an address as specified by the user in the request and in accordance with the specified delivery service level (step 604). In an embodiment, the physical sample includes all of the user content and appears exactly as it would when mailed to mailing list recipients. In an alternative embodiment, the physical sample of the mailpiece comprises at least a portion of the user content, but also includes, as part of the printed content of the sample, a printed advertisement (step 605). Preferably the printed advertisement is printed in an area where the user has not inserted user content. The advertisement may be in the form of a coupon or a discounted offer for the services of the mailing services provider (step 606). The advertisement thus not only shows the user what they can do with their own mailing (by inserting their own advertisements and coupons in place of the mailing services provider's advertisement), but also incentivizes the user to place an integrated mailing services product order with the mailing services provider.

Those of skill in the art will appreciate that the invented method and apparatus described and illustrated herein may be implemented in software, firmware or hardware, or any suitable combination thereof. Preferably, the method and apparatus are implemented in software, for purposes of low cost and flexibility. Thus, those of skill in the art will appreciate that the method and apparatus of the invention may be implemented by a computer or microprocessor process in which instructions are executed, the instructions being stored for execution on a computer-readable medium and being executed by any suitable instruction processor. Alternative embodiments are contemplated, however, and are within the spirit and scope of the invention.

What is claimed is:

1. An integrated document creation and mailing service user interface, comprising:
a document creation interface configured to allow a user to create a document to be mailed by a mailing service;
a mailing list interface configured to allow the user to specify a mailing list of addresses to which the created document is to be mailed; and
a mailing services order interface configured to allow the user to specify a mailing services level, to place an order with a mailing services provider to produce and mail the created document to recipients having addresses in the mailing list, the mailing services order interface configured to link the created document and specified mailing list into an integrated mailing services product and to associate the integrated mailing services product with an account associated with the user.

2. An integrated document creation and mailing service user interface implemented in accordance with claim 1, further comprising:
a guided wizard interface which guides a user through the creation of the mailpiece via the document creation interface and through the specification of the mailing list via the mailing list interface.

3. An integrated document creation and mailing service user interface implemented in accordance with claim 1, further comprising:
a user account interface configured to save the ordered integrated mailing services product and to display to the user when the user accesses the user account at a later time an offer for reordering the saved integrated mailing service product.

4. An integrated document creation and mailing service user interface implemented in accordance with claim 1, further comprising:
a control displayed to the user which, upon selection by the user, initiates a request to send a sample of the created mailpiece to a specified physical address.

5. An integrated document creation and mailing service user interface implemented in accordance with claim 4, wherein the specified physical address is an address of the user.

6. An integrated document creation and mailing service user interface implemented in accordance with claim Wherein the control allows the user to specify a delivery service level, allowing the user to test the delivery time of the desired delivery service level.

7. An apparatus implemented to provide the interface of claim 1.

8. A method allowing a customer of a mailing services provider to order a sample and test a delivery service of the mailing services provider, the method comprising the steps of:
providing a graphical user interface configured to allow the user to create or provide an electronic document from which a mailpiece can be produced and mailed by the mailing services provider, the electronic document comprising at least one content area comprising user content and including at least one area reserved for a recipient address;
providing a graphical user interface configured to allow the user to order a physical sample of the mailpiece and to specify a delivery service level.

9. A method in accordance with claim 8, further comprising:
responsive to a user ordering a physical sample of the mailpiece, producing the physical sample of the mailpiece and mailing it to an address specified by the user in accordance with the specified delivery service level.

10. A method in accordance with claim 9, wherein the physical sample of the mailpiece comprises at least a portion of the user content, an advertisement not provided by the user, and the address specified by the user printed or otherwise affixed in the area reserved for a recipient address.

11. A method in accordance with claim 10, wherein the advertisement is an advertisement for the mailing services of the mailing services provider.

12. An apparatus configured to implements the method of claim 1.
